(19) United States
(12) Patent Application Publication
(10) Pub. No.: US 2010/0078426 A1
(43) Pub. Date: Apr. 1, 2010

(54) Apparatus and method for maintaining a urea solution in a liquid state for treatment of diesel exhaust

(76) Inventors: Bob Xiaobin Li, Grand Blanc, MI (US); Michael J. Seino, Flushing, MI (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/286,652

(22) Filed: Oct. 1, 2008

(51) Int. Cl. H05B 6/02; H05B 3/02

(52) U.S. Cl. 219/600; 219/482

(57) ABSTRACT

A system for keeping a solution of urea in a liquid state comprising a tank having a level sensing apparatus, inlet and outlet tubes for supplying and withdrawing urea solution, and a plurality of non-contact heating elements disposed in vertical relationship to one another. Preferably, the heating elements are infrared (IR) radiative coils encased in IR-transparent quartz tubes. In one embodiment, each heating element represents a horizontally defined heating zone. When the reservoir tank is full and predetermined temperature conditions are met, all of the heaters are on, each heater irradiating its own horizontal zone. As zones are progressively emptied during consumption of the urea solution, as determined by the level sensor, each respective zone heater is de-energized. Because each horizontal zone is heated by a single heater, the solution is maintained at a substantially uniform temperature over the full depth of the tank without localized overheating.

### TECHNICAL FIELD

The present invention relates to emissions control in compression-ignited internal combustion engines; more particularly, to systems for injecting urea into diesel exhaust to scavenge nitrogen oxides; and most particularly, to a system for melting a reservoir solution of urea contained in a solid icing state at normally sub-freezing temperatures.

### BACKGROUND OF THE INVENTION

To scavenge oxides of nitrogen (NOx) from the exhaust of compression-ignited (CI) engines, and especially diesel engines, urea injection systems are commonly in use in the prior art. A urea and water solution is injected into the hot exhaust pipe, where urea is hydrolyzed into ammonia ahead of a selective catalytic reduction (SCR) converter. Ammonia reacts with NOx trapped on the catalyst face to form N₂, CO₂, and H₂O, thereby lowering the level of noxious emissions in the exhaust.

A problem in the prior art is that at temperatures below about −11° C., the urea solution can freeze. Thus, a thermal heating system and method are required to thaw the solid solution into a liquid solution (or to keep the solution from freezing) to permit a pump to draw solution for delivery into the exhaust pipe.

The problems inherent in providing such a system and method are considerable. Thawing a frozen reservoir of solution or providing continuous heat to the solution by electrical resistance is parasitic to the overall electrical energy balance of an engine, which can be a significant detriment especially in hybrid-electric vehicles. Urea solutions can be highly corrosive to some materials. A system must be able to spread heat to a large surface area while not over-heating the fluid to an un-necessary temperature level; thus, heater wattage density must be optimized, and the heater circuit must be well sealed or otherwise protected. The heater must be in continuous contact with the frozen and/or liquid solution as solution is being consumed, so that maximum heat transfer efficiency can be achieved.

Any of various prior art using contact heating devices may be considered to thaw the frozen solution, such as use of a PTC ceramic heating element enclosed in a protective skin, or resistance coil heaters submerged in the solution. However, such heating apparatus can only provide localized heating, and melt the ice surrounding the heater. Thus, the ice volume that can be readily melted is only a small portion of the ice within the large tank of urea ice. Furthermore, these heating devices melt the ice by heat conduction and convection through the media. These devices work well if there is no separation at the boundary of the melted liquid and the ice. However, this usually is not the case. As the melting ice transitions from the solid state to the liquid state going through the phase change, the volume reduces. This creates air pockets at the boundary between the liquid urea and solid urea ice. Moreover, as liquid urea solution is extracted from the container, an even larger air pocket is created between liquid and ice urea. Heat to melt the ice can only be transferred through this air pocket by radiation. These devices are not effectively designed for heating by radiation, thus resulting in a loss of heating efficiency.

What is needed in the art is an improved heating apparatus and method of use wherein heat is applied through a urea solution without local hot spots, and wherein heat is applied in proportion to the volume of solution present to prevent overheating and/or waste of electricity.

It is a principal object of the present invention to provide a reliable flow of liquid urea solution at ambient temperatures below the freezing point of the solution.

### SUMMARY OF THE INVENTION

Briefly described, a system for melting a reservoir solution of urea in a solid state at normally sub-freezing temperatures comprises a urea reservoir tank having an inlet port and an outlet port for supplying and withdrawing urea solution, a fluid level sensing apparatus (preferably continuous), a fluid pickup tube (preferably heated) and a non-contact heating device, such as an infrared (IR) emitter or a microwave emitter, controlled by an electrical controller. In one aspect of the invention, the non-contacting heating device is disposed on one side of the urea tank, such as for example the bottom of the tank, and encapsulated by a protective IR transparent jacket. Liquid urea, melted by the non-contact heater collects at the bottom of the tank where a pickup tube transports the urea liquid out of the tank. The tube may be heated to keep the urea in its liquid state. In another aspect of the invention, the heating device includes a plurality of non-contact heating elements disposed in vertical relationship to one another. Preferably, the heating elements are encased in IR-transparent protective tubes. Each heating element represents a horizontally defined heating zone. When the reservoir tank is full and predetermined temperature conditions are met, all of the heaters are on, each heater irradiating its own horizontal zone. As zones are progressively emptied during consumption of the urea solution, as determined by the fluid level sensor, the respective zone heaters are turned off, thereby conserving electricity. The melted fluid is then drawn by the pickup tube at the bottom of the tank and delivered to the vehicle exhaust pipe.

### BRIEF DESCRIPTION OF THE DRAWINGS

The present invention will now be described, by way of example, with reference to the accompanying drawing, in which:

FIG. 1 is an elevational schematic view of a system of a first embodiment in accordance with the present invention for melting a reservoir solution of urea in a solid state at normally sub-freezing temperatures; and

FIG. 2 is an elevational schematic view of a system of a second embodiment in accordance with the present invention for melting a reservoir solution of urea in a solid state at normally sub-freezing temperatures.

The exemplification set out herein illustrates one preferred embodiment of the invention, in one form, and such exemplification is not to be construed as limiting the scope of the invention in any manner.

### DESCRIPTION OF THE PREFERRED EMBODIMENTS

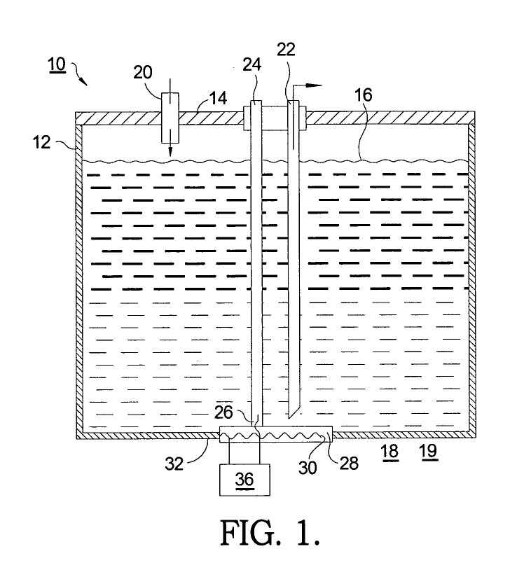

Referring to FIG. 1, an exemplary system 10 in accordance with the present invention for melting a reservoir solution of urea in a solid state at normally sub-freezing temperatures comprises a tank 12 having a sealable lid 14 for preventing leakage of a urea solution 16 during ordinary motion of the tank as can occur in use during operation of a vehicle 18 wherein system 10 is disposed. Typically, vehicle 18 is powered by a compression-ignited engine 19 such as a diesel engine. (For reference herein, system 10 is shown in FIG. 1 in correct gravitational orientation.) Tank 12 is provided with a fill tube 20 and an outlet tube 22 for respectively supplying and withdrawing urea solution.

Within tank 12 is disposed a level sensor apparatus 24, such as for example, a capacitive type fluid level sensor, for sensing the level of urea contained in the tank. A temperature sensor 26 for measuring the temperature of the urea is located near the bottom of the tank. A non-contact heater 28, for example an infrared or microwave heater, is used to melt the ice. Heater 28, including a heating element 30, is positioned to radiate within solution 16 and is contained in an IR-transparent sealed envelope 32, preferably a sealed thick wall quartz jacket. It will be seen that the tank of solution is heated radiantly by element 30. Preferably, level sensor apparatus 24 and temperature sensor 26 are in communication with and heating element 30 is controlled by a programmable controller 36.

In operation, when temperature conditions require, as programmed into controller 36 (for example, when sub-freezing conditions for solution 16 are either near or actually pertain), system 10 interrogates level sensor apparatus 24 and temperature sensor 26 and then energizes heating element 30. Preferably, the power level may be varied by the controller, the object being to raise or maintain the temperature of solution 16 above its freezing temperature within tank 12. The melted urea solution forms a liquid pool at the bottom of the tank where the pickup tube 22 extracts the liquid urea for usage. In one aspect of the invention, the pickup tube is heated to maintain the urea in its melted state.

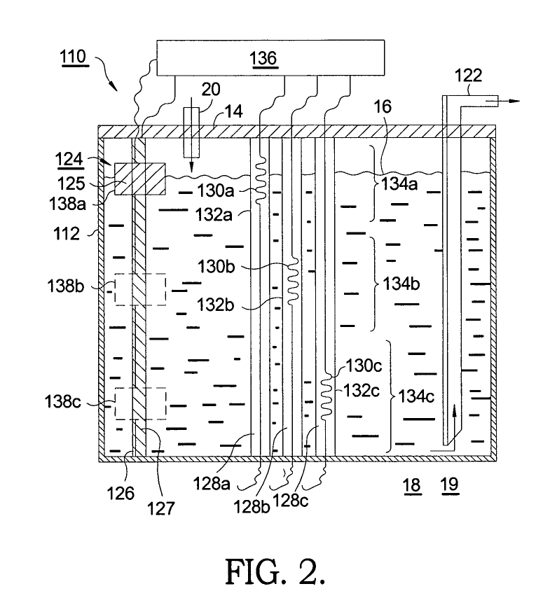

Referring to FIG. 2, system 110 in accordance with a second embodiment of the present invention for melting a reservoir solution of urea in a solid state comprises a tank 112 having a sealable lid 14 used in a vehicle 18 wherein system 110 is disposed. Typically, vehicle 18 is powered by a compression-ignited engine 19. Tank 112 is provided with a fill tube 20 and an outlet tube 122 for respectively supplying and withdrawing urea solution.

Within tank 112 are disposed a level sensor apparatus 124, such as for example, float 125, slidably fitted around stainless steel tube 127. A circuit board containing a bank of reid switches (not shown) is disposed within tube 127. A magnet embedded within float 125 sequentially closes the contacts in the reid switches, as the float travels up and down the tube, thereby detecting the level of urea remaining in the tank. A temperature sensor 126 for measuring the temperature of the urea is located near the bottom of the tank and preferably within tube 127. A plurality of submersible, non-contact heaters 128a, 128b, 128c, preferably infrared or microwave heaters is used to melt the ice. More or fewer heaters 128 may be employed as may be desired. Each heater 128 includes a heating element 130a, 130b, 130c, each of which is positioned to radiate substantially horizontally within solution 16 and each is contained in an IR-transparent sealed envelope 132, preferably a sealed thick wall quartz tube. A tube may contain more than one element if desired. Heating elements 130a, 130b, 130c are arranged in vertical relationship with respect to one another such that each horizontally-radiating heating element supplies heat energy to its respective horizontal zone 134a, 134b, 134c, the zones being defined thereby. It will be seen that the tank of solution thus comprises a stack of horizontal zones, each of which is heated independently of the others by one of elements 130a, 130b, 130c. Preferably, the level sensor, temperature sensor, and heating elements are in communication with and controlled by a programmable controller 136. Each heating element may be energized and de-energized directly by level sensor apparatus 124 output corresponding to the urea level.

In operation, when temperature conditions require, as programmed into controller 136, system 110 interrogates level sensor apparatus 124 as to the number of horizontal zones 134a,134b,134c occupied by solution 16 and then energizes those heating elements 130a,130b,130c in zones occupied by solution 16. Preferably, the power level in each zone may be varied by the controller, the object being to raise or maintain the temperature of solution 16 above its freezing temperature at all points within tank 112.

As liquid solution 16 is consumed by use in vehicle 18, zones 134a,134b,134c are progressively depleted of solution. As level sensor 124 recognizes a predetermined drop in level, for example from float position 138a to float position 138b, the upper heating element 30a is de-energized. As solution 16 is further consumed and zone 134b is emptied and float 125 descends to float position 138c, central heating element 130b is also de-energized, leaving only lower element 130c energized to continue heating zone 134c. Thus each zone is heated independently and electricity usage is optimized.

While the invention has been described by reference to a specific embodiment, it should be understood that numerous changes may be made within the spirit and scope of the inventive concepts described. Accordingly, it is intended that the invention not be limited to the described embodiment, but will have full scope defined by the language of the following claims.

What is claimed is:

1. A system for melting a reservoir solution of urea in a solid icing state at normally sub-freezing temperatures comprising a reservoir for containing said urea solution and at least one non-contacting heating element for melting said urea solution.

2. A system in accordance with claim 1 wherein said heating element is selected from the group consisting of infrared and microwave.

3. A system in accordance with claim 1 wherein said reservoir is divided into a plurality of vertically-arranged horizontal heating zones, wherein each of said horizontal heating zones contains at least one of said at least one non-contacting heating element.

4. A system in accordance with claim 3 further includes a controller, wherein each of said at least one non-contacting heating element is independently controllable by said controller and wherein each of said at least one non-contacting heating element is controllably energized to apply heat to a respective heating zone.

5. A system in accordance with claim 4 wherein each of said at least one non-contacting heating element is energized only when said zone is occupied by said solution of urea.

6. A system for melting a reservoir solution of urea in a solid icing state at normally sub-freezing temperatures, comprising:
a) a closed tank for retaining and supplying a volume of said solution;
b) a level sensor for determining the depth of said solution;
c) a plurality of heating elements disposed in said tank and arranged in vertical relationship with respect to one another such that each heating element supplies heat energy to a respective horizontal zone within said tank, a plurality of said zones being defined thereby; and
d) an apparatus for energizing and de-energizing each of said heating elements independently, responsive to signals from said level sensor.

7. A system in accordance with claim 6 wherein said heating elements are selected from the group consisting of infrared and microwave.

8. A system in accordance with claim 6 wherein said level sensor includes a float.

9. A system in accordance with claim 6 wherein each of said heating elements is encased in a sealed envelope.

10. A system in accordance with claim 9 wherein said sealed envelope is formed of quartz.

11. A system in accordance with claim 6 wherein more than one of said heating elements is enclosed in a single sealed envelope.

12. In a system for keeping a reservoir solution of urea in a liquid state at normally sub-freezing temperatures wherein the system includes a reservoir divided into a plurality of vertically-arranged horizontal heating zones wherein each of horizontal heating zones contains an independently controllable heating element, a method of operating the system comprising the steps of:
a) energizing each independently controllable heating element when a corresponding zone of said horizontal heating zones contains said solution of urea; and
b) de-energizing each independently controllable heating element when a solution criteria exists.

13. A system in accordance with claim 12 wherein said solution criteria is when the corresponding zone of said horizontal heating zones is depleted of said solution of urea.

14. A method in accordance with claim 12 including the further step of determining whether solution temperature criteria are met before energizing said heating elements.

15. A method in accordance with claim 15 wherein said solution temperature criteria include the freezing temperature of said solution.
